(19) United States
(12) Patent Application Publication
(10) Pub. No.: US 2010/0266855 A1
(43) Pub. Date: Oct. 21, 2010

(54) ADHESION-PROMOTING AGENT FOR PROTECTIVE COATINGS

(75) Inventor: David M. Zukowski, Sterling Heights, MI (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/746,531

(22) PCT Filed: Dec. 22, 2008
(86) PCT No.: PCT/US08/87924

§ 371 Date: Jun. 7, 2010

Related U.S. Application Data
(60) Provisional application No. 61/009,239, filed on Dec. 27, 2007.

(51) Int. Cl. B32B 15/08; C08G 18/00; B05D 3/02

(52) U.S. Cl. 428/425.8; 525/452; 427/388.2

(57) ABSTRACT

The present invention relates to an adhesion-promoting agent that contains at least 1.5 isocyanate groups per molecule and at least one urea linked silane group, coating compositions containing the adhesion promoting agent and methods for adhering protected coatings to a substrate. The adhesion-promoting agent is especially useful as an additive to the crosslinking component of a two component coating composition. The coating composition is especially useful for use as a protective coating on a previously coated or uncoated substrate such as an automobile.

### FIELD OF THE INVENTION

This invention is related to protective elastomeric coatings. The invention is particularly related to adhesion-promoting compounds useful as additives in protective elastomeric coatings.

### BACKGROUND OF THE INVENTION

The use of protective coatings is a growing industry, especially as truck bed liners. Protective coatings, especially truck bed liners can be found in a variety of forms, from a simple removable mat covering only the bottom of a truck bed, to a plastic tray formed in the approximate dimensions of the truck bed that is inserted into the truck bed.

Other bed liners are those liners that are obtained from fluent coating compositions that are applied in a relatively thick layer and cure on the truck bed to form an elastomeric coating adhered to the bed. These elastomeric coatings can be applied to vehicles by the owner in a do-it-yourself application method, or by a commercial aftermarket business, or by the original vehicle manufacturer as an option available on a newly built vehicle. In general, the elastomeric coating composition is applied directly to the vehicle after application of several paint layers, including an electrocoat layer, a primer layer, a layer or layers of basecoat, and a surface clearcoat layer. One deficiency of such coated products is that it can be difficult to obtain sufficient adhesion of a protective coating layer—such as a bed liner—to a clearcoat layer without chemically pre-treating or mechanically abrading the clearcoat surface. Clearcoats are typically hard surface coatings and are generally not easily adhered to. Thus, application of an elastomeric coating to a vehicle having a clearcoat surface may require time-consuming or costly process steps.

It can be desirable to have an elastomeric protective coating composition that can be adhered to a previously-coated substrate without the need to mechanically abrade or pretreat the substrate.

### SUMMARY OF THE INVENTION

In one aspect, the present invention is a polyurea coating composition comprising:
A) a crosslinkable component consisting essentially of compounds, oligomers and/or polymers that have amine functional groups; and
B) a crosslinking component comprising isocyanate functional compounds, oligomers and/or polymers;
wherein said crosslinking component includes an adhesion-promoting agent comprising the reaction product of a polyisocyanate and a isocyanate-reactive compound having at least one silicon-containing functional group.
In another aspect, the present invention is a method of adhering a protective coating to a coated substrate, wherein the coated substrate comprises a previously dried and cured coating layer, said method comprising the steps of:
   a. applying a polyurea coating composition to the coated substrate, wherein the polyurea coating composition comprises an adhesion-promoting agent that is the reaction product of (1) a polyisocyanate having, on average, at least 2.5 isocyanate groups per molecule with (2) an isocyanate-reactive compound having at least 1 silicon-containing functional group;
   b. curing the applied polyurea coating composition.

In another aspect, the present invention is a substrate coated by a dried and cured layer of a polyurea coating composition wherein the polyurea coating composition comprises an adhesion-promoting agent that is the reaction product of a polyisocyanate having, on average, at least 2.5 isocyanate groups per molecule and an isocyanate-reactive compound having at least 1 silicon-containing functional group.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are described, for brevity, in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

In one embodiment, the present invention is an improved elastomeric coating composition having improved adhesion to the surface of a previously coated substrate. It has been found that the addition of an adhesion-promoting compound of the present invention to a coating composition can provide a coating having excellent adhesion to the substrate to which the coating is applied. The adhesion promoting compound of the present invention comprises both isocyanate functionality and silane functionality. In particular, the adhesion promoting agent comprises one or more silane functional groups, and can be added to the crosslinking component of a two-component coating composition to provide improved adhesion. The adhesion-promoting agent may also increase the tensile strength of the cured coating composition.

The adhesion-promoting agent can be selected from compounds, oligomers, or polymeric materials that have (1) on average more than 1.5 isocyanate groups per molecule and (2) one or more silicon-containing functional groups. In the present description, a compound having a silicon-containing functional group can be referred to generically as a silane or polysilane functional compound—even though the compound may not technically be a silane or polysilane. One of ordinary skill in the art would know from reading the specification the various types of silicon-containing compounds are useful herein. Preferably the adhesion-promoting agent comprises more than one silicon-containing functional group and have a molecular weight, or in the case of an oligomer or polymer a number average or weight average molecular weight, of less than about 2000. Adhesion-promoting agents of the present invention are the reaction products of a polyisocyanate compound with a silane or polysilane functional compound having at least one isocyanate-reactive functional group. Suitable isocyanate reactive functional groups include epoxy groups, hydroxy groups, amine groups, carbamate groups, urea groups, amide groups, carboxylic acid groups, mercapto groups, and other isocyanate groups. In the practice of the present invention the isocyanate reactive functional group should react more quickly with the isocyanate group than with the silane group(s) that are present on the compound. Also, an epoxy group may not be sufficiently reactive on its own with an isocyanate group, and may need to be subject to catalysis, high temperatures and/or a ring opening reaction. Suitable adhesion promoting agents include, for example, 1-[3-(trimethoxysilyl)propyl]urea, gamma-mercapto propyl trimethoxy silane, 3-(trimethoxysilyl)propane-1,2-epoxide, 3-(trimethoxysilyl)propane-1-isocyanate or a combination thereof. Compounds having an amine group and one or more silane groups can be preferred.

The present invention, in a preferred embodiment, is directed to an adhesion-promoting agent of general formula (I) and its use in coating compositions:

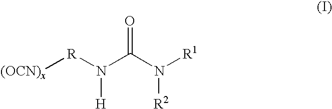

wherein R is a linking group having from 2 to 100 carbon atoms and R may optionally be substituted with one or more of the groups consisting of uretidione, isocyanurate, allophanate and biuret; x is 2 to 10; R¹ is (i) an alkyl group having from 1 to 6 carbon atoms substituted with one or more groups J or (ii) an aryl group having from 6 to 20 carbon atoms substituted with one or more groups J; R² is (i) H, (ii) an alkyl group having from 1 to 6 carbon atoms substituted with one or more groups J or (iii) an aryl group having from 6 to 20 carbon atoms substituted with one or more groups J; wherein each J is independently —Si(OR³)₃₋ₐR⁴ₐ; wherein R³ is an alkyl group having from 1 to 6 carbon atoms or an aryl group having from 6 to 20 carbon atoms; R⁴ is an alkyl group having from 1 to 6 carbon atoms or an aryl group having from 6 to 20 carbon atoms; and a is 0, 1, 2 or 3.

One preferred example of formula (I) is:

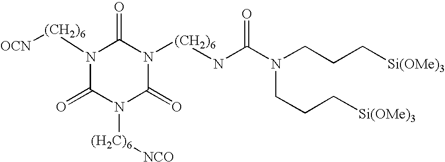

The above compound can be produced by the reaction of one mole of the isocyanurate trimer of 1,6-hexamethylene diisocyanate with one mole of N,N-bis(3-trimethoxypropylsilyl)amine.

The adhesion-promoting agent is preferably produced by contacting a polyisocyanate compound having, on average, at least 2.5 isocyanate groups per molecule with an amino silane compound. As used herein, the term “amino silane” means a compound comprising both an isocyanate-reactive amine functional group and one or more silane or siloxane functional groups, such as formula (II), below. In this process, it is desired to keep the ratio of isocyanate groups to isocyanate-reactive amine groups in the range of from 2.5:1 to about 20:1. It is also desired that the adhesion-promoting agent have, on average, at least 1.5 isocyanate groups per molecule. Optionally, to produce the adhesion-promoting agent, a catalyst and/or solvent can be added to the reaction mixture.

Suitable polyisocyanate compounds that can be used are, for example, aliphatic polyisocyanates, cycloaliphatic polyisocyanates, aromatic polyisocyanates, and polyisocyanate adducts or a combination thereof, preferably having, on average, at least 2.5 isocyanate groups per molecule. More preferably, the polyisocyanate compounds contain, on average, at least 3 isocyanate functional groups per molecule and can be, for example, isocyanurates of hexamethylene diisocyanate, allophanates of hexamethylene diisocyanate, biurets of hexamethylene diisocyanate, isocyanurates of isophorone diisocyanate, allophanates of isophorone diisocyanate, biurets of isophorone diisocyanate, or a combination thereof. One particularly useful isocyanate compound is HDT-LV2 polyisocyanate from Rhodia. This material is a mixture of isocyanate dimers, trimers and other higher oligomers based on 1,6-hexamethylene diisocyanate and has on average, about 3.2 isocyanate groups per molecule. Another suitable polyisocyanate are polyisocyanates containing allophanate groups.

Suitable secondary amino silanes can be, for example, N,N-bis(3-trimethoxysilyl)ethylamine, N,N-bis(3-triethoxysilyl)ethylamine, N,N-bis(3-triisopropoxysilyl)ethylamine, N,N-bis(3-tri-n-propoxysilyl)ethylamine N,N-bis(3-trimethoxysilyl)propylamine, N,N-bis(3-triethoxysilyl)propylamine, N,N-bis(3-triisopropoxysilyl)propylamine, N,N-bis(3-tri-n-propoxysilyl)propylamine or a combination thereof. Other suitable examples can be found, for example, in amino silanes of formula (II);

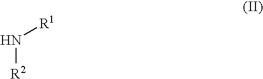

In formula (II), R¹ and R² are as described above in formula I.

Primary and secondary amino silanes can be useful in the practice of the present invention, however care must be taken when preparing the adhesion-promoting agent from a primary amino silane to ensure that the NCO:NH ratio is greater than about 5:1. In general, an NCO:NH ratio of 5:1 or less produces a waxy gel if a primary amine is used. Secondary amino silanes can be preferred.

In general, it is contemplated that the adhesion promoting agent of the present invention can be used in an otherwise conventional two-component coating composition. A “two-component coating composition” for the purposes of the present invention is a coating composition that is obtained by combining a crosslinkable component and a crosslinking component. In the practice of the present invention, the crosslinkable component comprises an isocyanate-reactive compound, oligomer, or polymer having isocyanate reactive functionality and the crosslinking component comprises a polyisocyanate-containing compound, oligomer, or polymer. The crosslinking component is used to interconnect, or crosslink, the crosslinkable component via reaction with the isocyanate-reactive functionality. In the practice of the present invention, the adhesion-promoting agent is added to the crosslinking component. It can be desirable to store the crosslinkable and crosslinking components separately to avoid premature crosslinking.

The crosslinking and crosslinkable components can be applied to a substrate in any manner that is conventional in the art, such as for example by spraying, brushing, or rolling a coating layer onto the substrate surface. The crosslinking component and the crosslinkable component can be pre-mixed just prior to application, or simultaneously applied and mixed on the surface of the substrate, as is known in the art.

The crosslinkable component consists essentially of compounds, oligomers and/or polymers that have amine functional groups that are able to react with isocyanate functional compounds, oligomers and/or polymers in the crosslinking component to form a crosslinked network. The two components are kept separate until it is time for application to a substrate.

In one embodiment, just prior to use, the two components are stirred together to form a pot mix. The pot mix can then be applied to the substrate by any known method including spray application, brushing, or roller coating. Alternatively, the two components can be applied using a plural component spray gun. When using a plural component spray gun to apply the coating composition to the substrate, the two components are metered from separate supply containers and can be mixed prior to entering the spray gun, they can be mixed in the spray gun or they can be mixed after leaving the spray gun, as in an impingement spray gun. The applied coating composition then is allowed to cure to form the protective coating. Curing can take place under ambient conditions or curing can take place at elevated temperatures.

Preferably, the adhesion-promoting agent comprises in the range of from 1 to 99 percent by weight based on the total weight of the crosslinking component. More preferably, the adhesion-promoting agent comprises in the range of from 2 to 75 percent by weight of the crosslinking component and most preferably, comprises in the range of from 3 to 50 percent by weight of the crosslinking component. The crosslinking component also comprises isocyanate functional compounds, oligomers and/or polymers and optionally, the crosslinking component can comprise other ingredients, such as, for example, solvent, crosslinking catalysts, pigments, stabilizers, etc.

Overall, the polyurea coating composition is formulated so that the ratio of isocyanate groups (NCO) in the crosslinking component to the amine groups (NH) is in the range of from 1:0.5 to 1:2. More preferably, the NCO:NH ratio in the coating composition is in the range of from 1:0.75 up to 1:1.5 and most preferably, the NCO:NH ratio is in the range of from 1:0.9 up to 1:1.1

Isocyanate functional compounds, oligomers and/or polymers that are suitable for use as the crosslinking component include, for example, 1,6-hexamethylene diisocyanate, allophanates, biurets, isocyanurates, uretidiones of 1,6-hexamethylene diisocyanate, isophorone diisocyanate, allophanates, biurets, isocyanurates, uretidiones of isophorone diisocyanate, 4,4′-diisocyanatodiphenylmethane, p-phenylene diisocyanate, 1,3-bis(isocyanatomethyl)-cyclohexane, 1,4-diisocyanatocyclohexane, 1,5-naphthalene diisocyanate, 3,3′-dimethyl-4,4′-biphenyl diisocyanate, 4,4′-diisocyanatodicyclohexylmethane, and 2,4-toluene diisocyanate, or mixtures thereof. Also suitable are polyisocyanate functional polymers, such as, for example, isocyanate-capped polyoxyalkylenes, isocyanate-capped polyols, isocyanate-capped polyamines and isocyanate-capped polyoxyalkylene diamines. Preferably, the major portion of the isocyanate composition is aliphatic. In one preferred embodiment, at least 75 percent by weight of the isocyanate is aliphatic, more preferably at least 90 percent by weight of the isocyanate is aliphatic and even more preferably at least 99 percent by weight of the isocyanate is aliphatic.

The coating composition comprising the adhesion-promoting agent of the present invention is a polyurea coating composition. The polyurea coating composition comprises a crosslinkable component consisting essentially of compounds, oligomers and/or polymers that have amine functional groups. Suitable amines can be chosen from, for example, primary, secondary, tertiary amines or a combination thereof. The amines may by monoamines, diamines, triamines or mixtures thereof. The amines may be aromatic or aliphatic (including cycloaliphatic), but are preferably aliphatic.

When formulating a polyurea coating composition for a truck bed liner, it is preferred to use amine functional compounds, oligomers and/or polymers that are difunctional or higher. Monoamines can be used, but the tensile strength of the resulting coating composition is lower compared to a coating composition comprising monomers that are difunctional and higher.

Examples of the aliphatic amines include, for example: ethylamine; all isomers of propylamine, butylamine, pentylamine, and hexylamine; cyclohexylamine; ethylene diamine; 1,2-diaminopropane; 1,4-diaminobutane; 1,3-diaminopentane; 1,6-diaminohexane; 2-methyl-1,5-diaminopentane; 2,5-diamino-2,5-dimethylhexane; 2,2,4-trimethyl-1,6-diaminohexane; 2,4,4-trimethyl-1,6-diamino-hexane; 1,11-diaminoundecane; 1,12-diaminododecane; 1,2-cyclohexane diamine; 1,3-cyclohexane diamine; 1,4-cyclohexane diamine; 1-amino-3,3,5-trimethyl-5-aminomethyl-cyclohexane; 2,4-hexahydrotoluene diamine; 2,6-hexahydrotoluene diamine; 2,4′-diamino-dicyclohexyl methane; 4,4′-diamino-dicyclohexyl methane; 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane); 2,4-diamino-toluene; 2,6-diamino-toluene; 2,4′-diaminodiphenyl methane; 4,4′-diaminodiphenyl methane; or a combination thereof.

An example of a particularly preferred amine includes an aliphatic amine, such as a secondary cycloaliphatic polyamine with high steric hindrance. One such amine is available commercially from UOP under the designation of CLEARLINK®. Other examples include, for example, JEFFLINK® 754, a secondary diamine available from Huntsman International of Salt Lake City, Utah and POLYCLEAR® 136, modified isophorone diamine, available from the BASF Corporation, Florham Park, N.J.

In another embodiment, the crosslinkable component is provided with an amine-functional resin such as an amine-functional oligomer and/or polymer. Preferably, such amine-functional resins are of a relatively low viscosity, suitable for use in the formulation of coatings. Preferably, the amine-functional resin is substantially free of solvent. Though any of a number of different resins may be suitable, a preferred resin is an aspartic ester-based secondary amine-functional resin, such as DESMOPHEN® NH1220 or NH1420 commercially available from Bayer Corporation, Pittsburgh, Pa. Other suitable amine-functional resins containing aspartate groups may be employed as well.

These aspartate amine-functional resins may be prepared in any suitable art-disclosed manner. For example, the subject matter described in U.S. Pat. No. 5,126,170, and/or 5,236,741, hereby incorporated by reference, may be employed as guidance. For instance primary monoamines or polyamines may be reacted with substituted or unsubstituted maleic or fumaric acid esters.

Without limitation, examples of substituted or unsubstituted maleic or fumaric acid esters suitable for preparing the aspartic esters include dimethyl, diethyl, dipropyl and di-n-butyl esters of maleic acid and fumaric acid, mixtures of maleates and fumarates, and the corresponding maleic acid esters, fumaric acid esters, or mixtures thereof, substituted by methyl in the 2-position, 3-position or both.

Examples of amines suitable for preparing the aspartic esters include, for example, ethylamine, the isomeric propylamines, butylamines, pentylamines, hexylamines, cyclohexylamine, ethylene diamine, 1,2-diaminopropane, 1,4-diaminobutane, 1,3-diaminopentane, 1,6-diaminohexane, 2-methyl-1,5-diaminopentane, 2,5-diamino-2,5-dimethylhexane, 2,2,4-trimethyl-1,6-diaminohexane, 2,4,4-trimethyl-1,6-diamino-hexane, 1,11-diaminoundecane, 1,12-diaminododecane, 1,2-, 1,3- and/or 1,4-cyclohexane diamine, 1-amino-3,3,5-trimethyl-5-aminomethyl-cyclohexane, 2,4- and/or 2,6-hexahydrotoluene diamine, 2,4′-diamino-dicyclohexyl methane, 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4-diamino-toluene, 2,6-diamino-toluene, 2,4′-diaminodiphenyl methane, 4,4′-diaminodiphenyl methane or a combination thereof.

Another group of preferred polyaspartic esters are derivatives obtained by reaction of dialkyl maleate or dialkyl maleate fumarate with cycloaliphatic polyamines having the general chemical structure of R—(CH₂NH₂)ₙ wherein n≧2 and R represents an organic group which is inert towards isocyanate groups at a temperature of 100° C. or less, and wherein R includes at least one cycloaliphatic ring. For example, without limitation, 1,3-bis-aminomethyl cyclohexane or 1,4-bis-aminomethyl cyclohexane, or a combination thereof.

Another suitable amine resin component can include, for example, high molecular weight amines, such as polyoxyalkylene amines in an amount of 0 percent to 50 percent, preferably 5 percent to 40 percent, and more preferably 7 percent to 30 percent. Suitable polyoxyalkylene amines contain two or more primary or secondary amino groups attached to a backbone, such as propylene oxide, ethylene oxide, or a mixture thereof. Examples of such amines include those offered under the designation JEFFAMINE® from Huntsman Corporation of Houston, Tex.

Polyurea coating compositions generally cure very quickly at room temperature due to the very fast reaction of the isocyanate functional group with an amine functional group. Typically, the polyurea coating is cured within seconds to a few (up to about 10) minutes. Due to the speed of the curing, polyurea coating compositions are typically applied to a substrate via a plural component spray gun. When using a plural component spray gun to apply the coating composition to the substrate, the two components are metered from separate supply containers and can be mixed prior to entering the spray gun, they can be mixed in the spray gun or they can be mixed after leaving the spray gun, as in an impingement spray gun. A plural component spray gun is the preferred method for applying a polyurea coating composition comprising the adhesion-promoting agent of the present invention to a substrate. The applied coating composition then is allowed to cure to form the protective coating. Curing can take place under ambient conditions or curing can take place at elevated temperatures.

The coating composition of the present invention can also comprise other components that can be added to either the crosslinkable component or the crosslinking component. The other components can be chosen from pigments, crosslinking catalysts, solvent, rheology control agents, fire retardants, water scavengers, light stabilizers, fillers and reinforcing agents, anti-static agents, or a combination thereof. If other components are added to the crosslinkable component, they should not materially affect the character of the final polyurea coating composition. For example, hydroxy functional compounds, oligomers and/or polymers should be limited as they can react with isocyanate functional components to form polyurethanes rather than the required polyureas.

One or more pigments may be provided in the composition. Pigment is preferably present in the coating composition in the range of from about 0 percent to about 20 percent by weight more preferably in the range of from about 3 percent to about 15 percent by weight and more preferably in the range of from about 6 percent to about 8 percent by weight, based upon the total weight of the coating composition. In a highly preferred embodiment, the resin includes a titanium dioxide pigment such as TI-PURE® R-741 commercially available from DuPont, Wilmington, Del. Another preferred pigment is RAVEN® 1250, carbon black, available from Columbian Chemicals, Inc., Marietta, Ga. Other pigments known to those of ordinary skill in the art may be used to create a cured protective coating composition that has nearly any color.

Suitable crosslinking catalysts include, for example, dibutyl tin dilaurate, dibutyl tin diacetoacetate, dibutyl tin diacetate, and other dialkyl tin diesters known to one of ordinary skill in the art.

Suitable solvents include, for example, aliphatic esters and acetates, aliphatic hydrocarbons, aromatic hydrocarbons and a combination thereof. Solvents can be used, but preferred coating compositions contain no solvent or very low amounts of solvent. For example, methyl ethyl ketone, methyl amyl ketone, methyl isobutyl ketone, toluene, xylene, acetone, ethylene glycol monobutyl ether acetate and other esters, ethers, ketones and aliphatic and aromatic hydrocarbon solvents may be used.

One or more light and/or thermal stabilizers may be provided in the composition. Preferably, the resin includes an ultraviolet (UV) light absorber and a visible light absorber for assisting coatings formed by the composition in resisting degradation caused by exposure to sunlight. Light absorbers are preferably present in the resin in the range of from about 0 percent to about 10 percent by weight. More preferably light absorbers are present in the range of from about 1 percent to about 7 percent by weight and even more preferably in the range of from about 2 percent to about 4 percent by weight, based upon the total weight of the coating composition.

Suitable light stabilizers include, for example, hindered phenols, aromatic amines, organophosphites, thioesters and the like. In a highly preferred embodiment, the resin includes about 2 percent by weight of a hindered amine light stabilizer such as TINUVIN® 292 commercially available from Ciba Specialty Chemicals and about 1 percent by weight of a hindered amine UV stabilizer such as TINUVIN® 1130 also commercially available from Ciba Specialty Chemicals.

The composition also may preferably include a thermal stabilizer for assisting the coatings formed by the composition in resisting degradation caused by exposure to thermal cycling. Thermal stabilizer is preferably present in the resin in the range of from about 0 percent to about 10 percent by weight more preferably in the range of from about 0.33 percent to about 2 percent by weight and even more preferably in the range of from about 0.66 percent to about 1.33 percent by weight, based upon the total weight of the coating composition. Preferably, the thermal stabilizer in the composition is an antioxidant. One highly preferred antioxidant is a phenolic antioxidant such as octadecyl 3,5-di-(tert)-butyl4-hydroxyhydrocinnamate sold under the tradename IRGANOX® 1076 and commercially available from Ciba Specialty Chemicals.

One or more fire retardants may also be provided in the coating composition. Fire retardant is preferably present in the coating composition in the range of from about 0 percent to about 10 percent by weight more preferably in the range of from about 1 percent to about 7 percent by weight and more preferably in the range of from about 2 percent to about 4 percent by weight, based upon the total weight of the coating composition.

Suitable fire retardants include, for example, powdered or fumed silica, layered silicates, aluminum hydroxide, brominated fire retardants, tris(2-chloroethyl)phosphate, tris(2-chloropropyl)phosphate, tris(2,3-dibromopropyl)phosphate, tris(1,3-dichloropropyl)phosphate, diammonium phosphate, various halogenated aromatic compounds, antimony oxide, alumina trihydrate, polyvinyl chloride, and the like, and combinations thereof.

The coating composition may also include components for controlling static such as about in the range of from about 2 percent to 5 percent by weight of a conductive carbon black, XC-72R® available from the Cabot Corporation, Boston, Mass. and PRINTEX® XE-2, available from Evonik Degussa GmbH, Dusseldorf, Germany. A highly preferred static controlling agent is a metal salt, such as a potassium salt (e.g. potassium hexafluorophosphate), which may be provided in an amount up to about 0.4 percent by weight of the crosslinkable and crosslinking components, based upon the total weight of the coating composition.

To prevent sagging of the uncured coating composition on, for example, a vertical surface, the composition may also include a thixotropic agent (thickener) in an amount in the range of from 0 percent to 10 percent, preferably about 1 percent to 8 percent, and more preferably in the range of from 2 percent to 4 percent, based upon the total weight of the coating composition. The thixotropic agent may also help in preventing the phase separation of pigments and other solids from the liquid chemicals during storage, transportation and application. Examples of thixotropic agents include, for example, fumed silica, such as, for example, Degussa AEROSIL® R-805 or R-972, or AEROSIL® 200, available from Evonik Degussa, Dusseldorf, Germany and CAB-O-SIL® TS-720 and CAB-O-SIL® PTG commercially available from Cabot Corporation, Boston, Mass., bentonite clay or a combination thereof.

The coating compositions can optionally include up to 10 percent by weight, based upon the total weight of the coating composition, of fillers. Suitable fillers include, for example, stone powder, glass fibers or spheres, carbon fibers, mica, lithopone, zinc oxide, zirconium silicate, iron oxides, diatomaceous earth, calcium carbonate, magnesium oxide, chromic oxide, zirconium oxide, aluminum oxide, crushed quartz, calcined clay, talc, kaolin, asbestos, cellulose, wood flour, cork, cotton and synthetic textile fibers, especially reinforcing fillers such as glass fibers and carbon fibers, polyaramids, especially KEVLAR® polyaramid floc, fiber, staple and pulp (available from DuPont, Wilmington, Del., KEVLAR® is poly(p-phenylene terephthalamide), as well as colorants such as metal flakes, glass flakes and beads, ceramic particles, polymer particles or a combination thereof. Any of the forms of KEVLAR® polyaramid are preferred.

Nearly any substrate may receive the coating composition to form a coating thereon. The polyurea coating composition may be applied to metal, plastic, or composite substrates, wood substrates or the like. In a preferred method, a layer of the coating composition is applied to a previously coated or uncoated substrate, such as, for example, a metal substrate, and then the applied layer is cured to form a polyurea coating on the substrate. The coating composition can be applied in various thicknesses depending upon the final use. For a truck bed liner, typical thicknesses of the cured coating are in the range of from 10 microns up to 1 centimeter or more. In highly preferred embodiments, the coating composition is applied to painted or electrocoated surfaces of automotive components (e.g., to form a truck bed liner, by coating one or more of the floor, side walls, head board, tail gate or other component of a pick-up truck cargo box) and may be applied in addition to or as a replacement for a clear coat. Depending on the desired texture of the coating, the composition may be applied to achieve a smooth surface (e.g., a class A finish) or a roughened or even coarse surface over part or the entire surface.

### EXAMPLES

The following abbreviations are used throughout the examples:

NH1420 is Bayer NH-1420®, aspartic ester diamine, and VPSL2371® and DES 3400 polyisocyanates are available from Bayer Material Science, Pittsburgh, Pa. DES 3400 is DESMODUR® 3400.

RAVEN® 1250 carbon black is available from Columbian Chemicals, Inc., Marietta, Ga.

SYLOSIV® A-4 moisture scavenger is available from W. R. Grace, Columbia, Md.

JEFFAMINE® T-3000, XJT-509, and T-430 polyamines are available from Huntsman International, Salt Lake City, Utah.

JEFFLINK® 754 diamine is available from Huntsman International, Salt Lake City, Utah.

SILQUEST® A-1110 and A-1170 amine silanes and SILQUEST® A-187 epoxy silane are available from Momentiv Performance Materials, Wilton Conn.

TINUVIN® 292, hindered amine light stabilizer is available from Ciba Specialty Chemicals Corporation, Tarrytown, N.Y.

RAP® 10 polyisocyanate prepolymers are available from Reactamine Technology, Conyers, Ga., a member of the Amber Chemical Group.

HDT-LV2® polyisocyanate is available from Rhodia Inc., Cranbury, N.J.

Preparation of Coated Steel Panels

Coated steel panels were prepared by electrocoating steel panels with CORMAX® 6 electrocoat composition according to the manufacturer's instructions. The electrocoated panels were then coated with 554-DM726 primer and baked for 30 minutes at 149° C. The primed panels were cooled and coated with an OEM basecoat composition, 686-DM640, followed by RK-8073, Gen® 5W clearcoat and baked at 140° C. for 30 minutes. The panels were cooled to room temperature and were used as is. All coatings are available from DuPont, Wilmington, Del., and sprayed and baked according to the manufacturer's instructions. Additional panels were prepared by spraying the bed liner material over cleaned thermoplastic polyolefin panels, in which the bed liner material can be easily removed later as a free film.

Preparation of Adhesion-Promoting Agent #1-7

To a flask with a stirring blade, thermometer, addition funnel and nitrogen inlet was added Rhodia HDT-LV2® polyisocyanate. This was stirred and either SILQUEST® A-1170 or A-1110 amino silanes (according to table 1) was added at such a rate so that the temperature of the reaction was maintained below 60° C. When the addition was complete, the mixture was stirred at 50° C. for 1 hour then allowed to stand overnight at room temperature (approximately 72° C.). All amounts in Table 1 are in parts by weight.

TABLE 1

| Ingredient | 1 | 2 | 3 | 4 | 5 | 6 | 7 |
|---|---|---|---|---|---|---|---|
| HDT-LV2 | 61.57 | 75.38 | 80.95 | 83.62 | 85.96 | 87.72 | 89.77 |
| NCO eq wt. 183 | | | | | | | |
| SILQUEST ® A- | 38.43 | 0 | 0 | 0 | 0 | 0 | 0 |
| 1170 | | | | | | | |
| NH eq wt 342.6 | | | | | | | |
| SILQUEST ® A- | 0 | 24.62 | 19.05 | 16.38 | 14.04 | 12.28 | 10.23 |
| 1110 | | | | | | | |
| NH eq wt 179.3 | | | | | | | |
| Total | 100 | 100 | 100 | 100 | 100 | 100 | 100 |
| NCO:NH ratio | 3 | 3 | 4.16 | 5 | 6 | 7 | 8.6 |
| Viscosity@38° C., | 2812 | gel | gel | gel | 3356 | 2868 | 1845 |
| centipoise | | | | | | | |

### Preparation of Polyurea Coating Compositions

TABLE 2

| Ingredient | 1* | 2* | 3* | 4* | 5 | 6 | 7* | 8* |
|---|---|---|---|---|---|---|---|---|
| | Amine crosslinkable component 1a | | | | | | | |
| NH1420 | 8.99 | 8.99 | 9.53 | 9.59 | 8.99 | 8.99 | 8.99 | 8.99 |
| RAVEN ® 1250 | 1.36 | 1.36 | 1.44 | 1.45 | 1.36 | 1.36 | 1.36 | 1.36 |
| SYLOSIV ® A-4 | 3.41 | 3.41 | 3.61 | 3.63 | 3.41 | 3.41 | 3.41 | 3.41 |
| | Amine crosslinkable component 1b | | | | | | | |
| NH1420 | 3.82 | 3.82 | | | | | | |
| JEFFAMINE ® T-5000 | 17.72 | 17.72 | 12.7 | 12.78 | | | | |
| JEFFAMINE ® XT-J509 | | | | | 11 | 12.99 | 12.99 | 12.99 |
| JEFFLINK ® 754 | 12.81 | 12.81 | 13.17 | 13.25 | 18.5 | 18.5 | 18.5 | 18.5 |
| JEFFAMINE ® T-430 | | | 3.18 | | | 0.5 | 0.5 | 0.5 |
| SILQUEST ® A-1110 | | 4.05 | 4.03 | | | | | |
| SILQUEST ® | | | | 3.85 | 2.7 | | | |
| A-1170 | | | | | | | | |
| | Isocyanate crosslinking component | | | | | | | |
| TINUVIN ® 292 | 0.5 | 0.5 | | | 0.5 | 0.5 | 0.5 | 0.5 |
| Tin Cat. | | | | | | 0.1 | 0.1 | 0.1 |
| TINUVIN ® 292 | | | 0.53 | 0.53 | | | | |
| Tin Cat. | | | 0.1 | 0.1 | 0.1 | | | |
| VPLS2371 | 26.47 | 25.56 | 16.55 | 18.9 | | | | |
| DES 3400 | 25.94 | 31.88 | 35.16 | 32.71 | 26.71 | 25.56 | 23.62 | 27.53 |
| RAP 10 | | | | | 23.88 | 19.28 | 22.69 | 22.75 |
| Adhesion-promoting | | | | | 2.57 | 8.6 | 2.57 | |
| agent #1 | | | | | | | | |
| HDT-LV2 | | | | | | | | 3 |
| SILQUEST ® | | | | | | | 3.72 | |
| A-187 | | | | | | | | |
| NCO:OH ratio | 1.01 | 1.05 | 1.05 | 1.05 | 1.023 | 1.02 | 1.02 | 1.1 |
| Mix Ratio | 1:1 | 1:1 | 1:1 | 1:1 | 1:1 | 1:1 | 1:1 | 1:1 |
| Amine:Isocyanate | | | | | | | | |

*denotes a comparative example

The ingredients of Amine portion 1a were mixed in a suitable mixing vessel using a high speed-dispersing blade for 1 hour. The ingredients of amine portion 1b were then added in the order shown in Table 2 and the ingredients were mixed for 4 minutes at 2000 rpm on a FlackTek SpeedMixer® DAC 400 FVZ available from FlackTek Inc., Landrum, S.C. In a separate mixing vessel, the ingredients of the isocyanate portion were mixed in the order shown in Table 2. The components were applied to coated steel panels via a plural component spray gun from available from COX N.A., Haslett, Mich., and static mix spray tube from Plas-Pak Industries, Norwich Conn., using a 1:1 mixing ratio to a dry film thickness of 40 to 60 mils. The panels were then allowed to stand at room temperature for 168 hours. The coatings were then tested for 90° peel adhesion to the substrate at 2 inches/min peel rate. The free film tensile strength was measured by cutting bedliner free film samples using a ASTM D412 standard dumbbell Die C, and by using an Instron® universal testing instrument at a strain rate of 20 inches/min. Several of the adhesion tests were repeated. The results of the testing are given in Table 3.

TABLE 3

| | 1* | 2* | 3* | 4* | 5 | 6 | 7* | 8* |
|---|---|---|---|---|---|---|---|---|
| Adhesion | 5.7 | 29 | 6.5 | 14.2 | 27.1 | 27.5 | 14.45 | 1.35 |
| (lbs./in) | | | | | | | | |
| Adhesion | 6.3 | | 9 | | 24.95 | 33.9 | | |
| retested | | | | | | | | |
| (lbs./in) | | | | | | | | |
| Tensile | 1125 | 707 | 1546 | 1567 | 1582 | 2160 | 1274 | n/a |
| Strength (psi) | | | | | | | | |

*denotes a comparative example

Coating 2 shows that adding an amino siloxane, especially an amino siloxane having only 1 siloxane per amine group, to the amine crosslinkable component increases the adhesion but lowers the tensile strength over a coating having no amino silane, coating 1. The decrease in tensile strength may be due to the chain-stopping effect of the monoamine.

Coating 3 attempted to increase the tensile strength by adding a lower molecular weight amine, JEFFAMINE® T-430 in place of some of the higher molecular weight amine JEFFAMINE® T-5000. Lower adhesion resulted.

Coating 4 shows that a secondary amine having two siloxane groups per molecule, SILQUEST® A-1170, added to the amine crosslinkable component resulted in a modest increase in adhesion and tensile strength and showed it could be used similarly to a primary amino silane in the amine crosslinkable component.

Coating 5 adds SILQUEST® A-1170 to the amine crosslinkable portion and adhesion promoting agent #1 to the crosslinking component. This coating has very good adhesion to the substrate and relatively good tensile strength.

Coating 6 adds adhesion-promoting agent #1 only to the crosslinking component. The results show very good adhesion and a high tensile strength.

Coating 7 adds epoxy silane and uses low levels of adhesion-promoting agent #1 to the crosslinking component to yield a coating with a relatively low adhesion and tensile strength.

Coating 8 is an example that uses no silane in either the crosslinkable component or the crosslinking component. The result is very low to no adhesion. Tensile strength was not tested.

Coating compositions 6 and 7 were then tested for in-can stability. In this test, the coating compositions were prepared and immediately after preparation, a portion of the coating composition was applied to previously coated steel panels as above. The remaining coating composition was aged in its preparation vessel for 3 to 27 days, and then applied to previously coated steel panels using the procedure given above. Another sample of each of the coating compositions were aged for 24 hours at 60° C. The coating composition was cooled to room temperature and applied to a previously coated steel panel using the same procedure as given above. The adhesion of the aged samples was then tested. Results of these tests are given in Table 4.

TABLE 4

| Aging time | Coating composition 5 | Coating composition 6 |
|---|---|---|
| 0 days | 33.8 | 30.1 |
| 3 days | 26.0 | 28.7 |
| 12 days | 20.75 | 28.1 |
| 27 days | 25.0 | 33.95 |
| 24 hours at 60° C. | 18.5 | 28.6 |

The results of this test show that adhesion of a coating composition where the crosslinkable component contains an amino silane is time dependent. It is possible this is due to the self-condensation of the amino silanes or reaction of the amino silanes with a source of hydroxy groups and/or water (in general, JEFFAMINES® contain a small amount of hydroxy functional groups). The adhesion of a coating composition where the adhesion amino silane is in the form of the adhesion-promoting agent of the present invention is not time dependent nor does it change when subjected to 24 hours at a high temperature.

1. A substrate coated by a dried and cured layer of a polyurea coating composition wherein the polyurea coating composition comprises an adhesion-promoting agent that is the reaction product of a polyisocyanate having, on average, at least 2.5 isocyanate groups per molecule and an isocyanate-reactive compound having at least 1 silicon-containing functional group.

2. The substrate of claim 1 wherein the isocyanate-reactive compound is an amine.

3. The substrate of claim 1 wherein the adhesion-promoting agent has, on average, at least 1.5 isocyanate groups per molecule and, on average, 2 or more silicon-containing functional groups per molecule.

4. The substrate of claim 1 wherein the adhesion-promoting agent is;

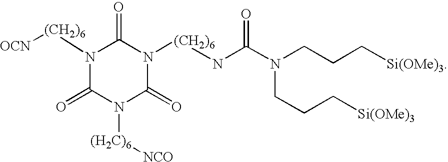

5. The substrate of claim 1 wherein the substrate is a metal substrate.

6. The substrate of claim 1 wherein the substrate is a component of a truck.

7. A polyurea coating composition comprising
A) a crosslinkable component consisting essentially of compounds, oligomers and/or polymers that have amine functional groups; and
B) a crosslinking component comprising isocyanate functional compounds, oligomers and/or polymers;
wherein said crosslinking component includes an adhesion-promoting agent comprising the reaction product of a polyisocyanate and a isocyanate-reactive compound having at least 1 silicon-containing functional group.

9. The coating composition of claim 7 wherein said isocyanate-reactive compound is an amine.

10. The polyurea coating composition of claim 7 wherein the isocyanate-reactive compound is N,N-bis(3-trimethoxypropylsilyl)amine.

11. The polyurea coating composition of claim 7 wherein the adhesion-promoting agent is;

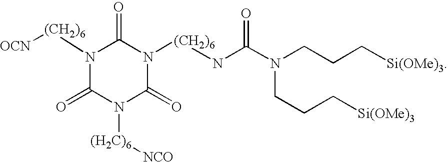

12. The polyurea coating composition of claim 7 wherein the adhesion-promoting agent comprises, on average, at least 1.5 unreacted isocyanate functional groups per molecule.

13. The polyurea coating composition of claim 7 wherein said adhesion-promoting agent is produced by the process of contacting a polyisocyanate compound with an isocyanate-reactive secondary amine compound having at least 1 silicon-containing functional group; wherein the ratio of isocyanate functional groups to amine functional groups is in the range of from 2.5:1 to 20:1.

14. The polyurea coating composition of claim 7 wherein the isocyanate-reactive compound comprises an amine functional group and 2 or more silicon-containing functional groups.

15. The polyurea coating composition of claim 8 wherein the ratio of isocyanate groups in said crosslinking component to amine groups in said crosslinkable component is in the range of from 1:0.5 up to 1:2.

16. The polyurea composition of claim 7 wherein said reaction product is: a polyisocyanate functional allophanate; a polyisocyanate functional isocyanurate; or a polyisocyanate functional biuret.

17. A method of adhering a protective coating to a coated substrate, wherein the coated substrate comprises a previously dried and cured coating layer, said method comprising the steps of:
a. applying a polyurea coating composition to the coated substrate, wherein the polyurea coating composition comprises an adhesion-promoting agent that is the reaction product of (1) a polyisocyanate having, on average, at least 2.5 isocyanate groups per molecule with (2) an isocyanate-reactive compound having at least 1 silicon-containing functional group;
b. curing the applied polyurea coating composition.

18. The method of claim 17 wherein the isocyanate-reactive compound is an amine.

19. The method of claim 17 wherein the previously dried and cured layer of coating composition comprises a resin having silane functional groups.

20. The method of claim 17 wherein the substrate is a motor vehicle.

21. The method of claim 17 wherein the substrate is a truck bed.
